(19) United States
(12) Patent Application Publication
(10) Pub. No.: US 2005/0120045 A1
(43) Pub. Date: Jun. 2, 2005

(54) Process for determining recording, and utilizing characteristics of website users

(76) Inventor: Kevin Klawon, Troy, OH (US)

Correspondence Address: KEVIN KLAWON, 428 EAST MAIN ST., TROY, OH, 45373, US

(21) Appl. No.: 10/993,520

(22) Filed: Nov. 18, 2004

Related U.S. Application Data
(60) Provisional application No. 60/524,270, filed on Nov. 20, 2003.

(51) Int. Cl. G06F 17/00

(52) U.S. Cl. 707/102

(57) ABSTRACT

The subject invention comprises a process that provides for analyzing characteristics of website users, indicating the behavior modes and attitudes of particular individuals or entities using a given website on the internet from a perspective of both real-time and historical time, with attitude attributes and other relevant attributes extracted from characteristics of verbal colloquy on such website, where such attitude data relative to such website is extracted and interpreted and stored on an individual basis and potentially on a group basis for future reference use purposes. Among other means, attitude is obtained in this process from interactive real-time communications, usually bi-directional live communication, that the website user conducts on website visits, or through emails or telephone callings, or any other mode of communication.

### C. PRIOR PROVISIONAL FILING

This application is a continuation and/or based upon a provisional patent application fired on the subject matter herein said provisional application being filed in the United States Patent Office on Nov. 20, 2003. (Provisional Application No. 60/524,270.

### D. BACKGROUND AND DISCUSSION OF PRIOR ART

Individual web-sites on the internet cater to a wide array of individuals, each seeking a unique set of services, products, information or the like. Correspondingly, there is a wide and vast variety of websites, as to products or services tendered or information. This variation and number of websites vary because of this very diversity of interests in users of the multitude of websites.

By reason of the foregoing, it is an obvious conclusion to understand that specialized websites are tailored to meet unique needs and interests. A specific website owner who is cognizant of the vagaries and demands of website users will be better equipped to constantly and frequently restructure his website and product service system to attract and keep clientele on an ongoing basis and more productive and profitable basis.

This updating process of a web-site, for successful maintenance and building of a better and higher customer base can potentially be implemented in large part with an accurate view of customer needs, habits, attitudes toward the product and other attributes. Variably stated, the more the website owner knows about his customer or clientele, and their respective attributes and attitudes and how they react to and use the website, the more optimal it will be for such website owners to create improvements to such system.

In this later respect, there are a wide variety of attributes and attitudes of a customer in using a website that can be determined and stored for future reference purposes and used to seek improvements in a given marketing system. Many characteristics about the user can be determined from usage of a website or other electronic, telephonic or other purchase mediums outside the world wide web.

This data is not presently significantly or effectively collected and stored on an individual basis as well as a group basis to determine trends and general habits, interests, and characteristics of all usage facets of users of the given website. Because of such circumstances there is an implicit and explicit calling for a means or solution to increase the effectiveness of customer relations and website revenues by more personalized relationships with customers.

At present, some limited efforts have developed technologies and applications focused on extracting appropriate information form websites and the databases behind websites. By using analytics and algorithms, such prior applications have developed only limited intelligent reporting systems for enterprise use in marketing and other areas. These existing tools have become very complex and can only provide general knowledge of how customers interact with the site, and such existing applications fail to provide insight into how to productively interact with any specific customer for sales potential and customer satisfaction. One of the reasons for this failure is the use of non-specific, enterprise website information. Another pertinent limitation of existing programs in this area is often the very intrusive nature of such technologies in deployment with customers themselves, all of which appear to override the privacy issue.

It is thus important to have knowledge of real-time behavior and attitudes of visitors on websites, and insights into how best to communicate with those customers individually to increase the probability of a successful customer encounter, without jeopardizing individual privacy, by combining actual customer comments with actual behavior and attitude patterns and specific shopping cart activity, these insights can be used to build customer strategies, and develop marketing for clients to re-design or overhaul their websites. It is vital as stated that any such interaction be unobtrusive to customers and can be easily deployed on the client's website.

In this light, such updating process on a web-site, for successful maintenance and building of a better and larger customer base should be implemented in greater part with an accurate view of customer needs, habits, attitudes toward the product and other attributes. Variably stated, the more the website owner knows about his customer or clientele, and their respective attitudes and how they react to and use the website the more optimal it will be for process of creating improvements to such system.

Any such data can be potentially stored on an individual basis as well as a group basis to determine trends and general habits, interests, and characteristics of all usage of the website, on a collective statistical purpose. Such collection and recapitulation of such data as a reference board in any useful detail is not undertaken to any degree by any web-site software realms.

Alternatively stated any system that does not permit a website owner to interact with individual web customers, in real time, with a personal approach to building relationships and revenues on the website, is not a sufficient an interactive tool or as effective face-to-face communications with a customer. In this later aspect, all too frequently, websites as an information warehouse, which potential customers often browse for information anonymously, are not used by the website owner to assist in that process of obtaining better customer relations. Therefore, it is important that a website owner identify visitors individually as soon as the visitor arrives at the website. At this juncture one does not have the necessary software programming to effectively retrieve and effectively use such critical information, including the total number of visits previously made to the Website, including pages that customer visited, average time spend on each page, and a log of all customer conversations, among other data items all to ascertain customer attitudes and habits relatively for a complete customer perspective and personal interactions through a website.

Moreover, at present website navigation with specific customer inquiries such as, buying, ordering or support is available only by requiring the customer to use a second mode of communication, such as telephone means, or wait for a reply by email by additional steps in this process. By adding such “latter” steps, it reduces the opportunity for potential on sight buying and cross-selling needed to increase customer services and revenue.

Alternatively stated any potential system that permits the website owner to interact with individual web customers, in real time, will thereby have at hand a personal approach to building relationships and revenues on the website, rendering the website an interactive tool as effective face-to-face communications with a customer, and at greater efficiency. In view of the above, the following delineated objects are set forth below.

### E. OBJECTS OF THE INVENTION

It is the primary object of the subject invention to set forth a system ascertaining the attitudes and behavior attribute of individuals using various websites.

Another object of the subject invention is to provide an improved software program that helps determine certain attitude characteristic of web surfers or users;

Still another object is to determine aggregate data and website usasge and calculate attributes of individuals using certain types of websites;

A further object of the subject invention is to provide an improved system for evaluating attitude characteristics of website users;

Another object of the subject invention is to provide an improved system for determining the attitude characteristics of a website user;

An object of the invention herein is to provide a data processing apparatus with a feedback mechanism on customer attributes and tally various data items about the website user;

Another object of the invention is to collect and interpret customer attitude data as to a given website that can be recalled and evaluated on an individual customer basis and overall customer group basis;

Yet another object of the invention is to provide a base for data processing of customer attitude and web site usage habits and attributes in various forms of internet usage;

Further objects of the subject invention will be apparent from a reading of the description taken in conjunction with the claims.

### F. BRIEF DESCRIPTION OF THE DRAWINGS

FIG. 1 demonstrates the overall hardware schematical arrangements used to implement the steps set forth herein;

FIG. 2 is a processing chart demonstrating the general overall flow of the processing steps used herein;

FIG. 3 sets forth a flow chart indicating the overall flow of processing to used in the subject systems, as used on a more particularized basis;

FIG. 4 demonstrates a flow chart for the process used herein on a detailed basis.

### G. DESCRIPTION OF GENERAL EMBODIMENT AND SUMMARY OF INVENTION

The subject invention comprises a process that provides for a basis that allows for analyzing characteristics of website users, indicating the behaviors and attitudes of particular individuals or entities using a given website on the internet from a perspective of both real-time and historical time, with attitude attributes extracted from characteristics and verbal colloquy used by a customer on such website. This attitude data relative to such website is extracted and interpreted and stored on an individual basis and potentially on a group basis for future reference for many purposes, including improving customer relations. Among other matters, attitude data is obtained in this process from interactive real-time communication, usually bidirectional live communication, that the user conducts on specific web site visits, emails or telephone callings, or any other mode of communication to a website or by other modes used in the offering of services or products.

Stated in general, the subject invention is a system for ascertaining specific characteristics of relevant attitudes and habits of website users on a general overall basis and from an individual basis as being delineated as to specific or non-specific categories. As to specific categories, website usage is studied to ascertain specific habits, behavioral modes and particularly attitudes of the user, such as the users attitude towards a given website, its products, and services and other relevant aspects of the website offerings. This information is collected from either a statistical, stochastic mode or from a generalized informational format; and various analysis modes can be used for such purpose.

Alternately stated, the subject invention comprises a process that allows for analyzing characteristics of website users, indicating the behavior and attitudes of a particular individual or entity using a given website on the world wide web (internet) from a perspective of both real-time and historical time, looking to individual website usage habits such as, for example: what pages the user visited, when the user visited, the order of the pages that the user followed on the site, how long the user visited, and how often the user visits the site, among any number of other habit characteristics. This habit data is then stored and updated on an individual basis and potentially on a group basis for future reference purposes. Moreover, most significantly and somewhat critical, customer attitudes can be obtained from such habit characteristics, but mostly such attitude data is available from interactive real-time communications, defined as bi-directional live communication or other communications, that the website user conducts on specific web visits or on several such visits or through emails, telephone, or any other method of spoken or written communication or any other means employed by the user.

In this respect any website user, implicitly or explicitly expresses attitudes in the usage of the website. These implicit or explicit expressions of attitude through questions and general conversations, in the usage of an internet site will reveal specific attitude information. The collection and ultimate usage of such attitude data will substantially help the website user adjust his website format and services for improved customer satisfaction and loyalty.

Further, this attitude information forms in large part the main and critical focus of the subject invention as such website attitude data can provide the most valuable informational tool to help determine ways to improve customer relations. Thus, the subject invention, from a broad perspective, involves herein a structural system to allow the owner of a given website to review particularized usage characteristics of an individual to learn more fully the likes and dislikes of a customer, and his or her perceptions and impressions, referred to as attitudes of a multitude of aspects of the business. Such website monitoring potentially senses activity and attitudes involved from one individual use and attitude to another. By obtaining such customer information, the website owner will learn from data what steps may be needed to improve the website, and cater to the desires and practices of such users. This will obviously help the web owner learn more about unique characteristics of his potential customers or clients for a specific website and learn better how to structure and use such website to keep customers and gain more customers.

In order to practically effect these means, as stated, the subject invention comprises a process and means for structural analysis to obtain a statistical or other overview of all the websites users in the system. The overall processing system includes basic steps more fully outlined below.

One such approach, of several, that can be utilized to determine customer attitude attributes, would be to use particularized categories of habit and behavior and determine attitude attributes therefrom and place such information in an overall matrix. This matrix will have, for example, one or more approaches listing of the various categories that are to be studied in this analysis wherein some limited data can be determined from specific habits and traits of an individual, including on web site dialogue.

In this latter perspective, the habits of a website user arise from the entire input he or she places in the system. Specifically, in on-line communication or other on-line services, an individual using a keyboard will connect with a website in real time on a display screen. Using a personal computer or other vehicles for making website entries and possibly conducting conversation in this process, such as asking questions about the web site, the individual user can perform various tasks on the computer, including entries into the system and conversational interchange over any length of time. The contents or modes of this visit, including conversation, are stored and the stored data can be revisited by the website owner to analyze the same for determining possible needed improvements to the owners entire business mode. Such stored information may include, by way of example, among numerous data items the following usage or habit characteristics, including conversational characteristics:
(1) length of the visit;
(2) the time of the visit, date and herein;
(3) the result of the visit—such as was there a purchase selection, or action consummated on the website as such website contemplates
(4) was there any particularized questions in addressing the website;
(5) how frequently was the website visited by an individual;
(6) how long did the website visitor dwell on a new area of subject on the website;
(7) what was the category of section or purchase by the we site user;
(8) how much money was spent by the individual at the website, if appropriate;
(9) what is the geographic location of the website user;
(10) if the website user visits the website frequently what products are purchased and at what frequency;
(11) if the website user registered any complaints, and with what rhetoric;
(12) whether the user was satisfied or dissatisfied through registered comments on the site.
(13) credit history of client;
(15) payment history of client;
(16) many other areas of usage, or other information about the usage, including, but not limited to attitude information stemming from either unidirectional or bi-directional conversation between the website user and the website monitor.

Once this data is stored, it becomes a source of continually renewable information that could be at hand to evaluate the habits and especially the attitudes of the website user. As stated, this conversational information and usage habit data will be analyzed from many aspects and parameters to determine an individual's attitudes on many facets of the website service, such as product delivery, product inclinations and dislikes, website responses, among a complete array of additional attitudes facets.

In this regard, the core technology architecture employed herein centers around and is thus mainly focused on real-time communications, personalization, and download technology, as consummated through a single agent interface for targeting single point customer from knowledge and communications as found on the web. Moreover, this core architecture is the main impetus for the key features of the technology herein, directed through browser-based communications, behavior/revenue studies, personalization technology, with a single-pixel intelligence engine. The technology architecture combined with the base technology features produces a customer personalization analytics communicator (CPAC) engine. From a broad perspective, involved herein this is a structural system that is provided to allow, in particular, the owner of a website to review particularized usages to learn precisely and generally what type of activity is involved from one individual use to another, including customer attitude reflections.

Moreover, relative to the projected usage of the inventive technology herein, the proposed thrust is to gain maximum insight customer into communications for ascertaining attitudes. In this process behavior and attitude analysis combined with direct customer communication over the web will function to help find ways to increase client satisfaction and thereby maximum return on investment. This information technology will also enable the website owner to:
1. Improve the understanding of customer website navigation and customer purchase or non-purchase behavior on the website;
2. improve website design to maximize purchases and their revenue based on visitor patterns and behavior;
3. generate incremental website revenue from potential customer impulse purchases and increased overall purchase demand;
4. initiate real-time effective and productive communication with customers, both reactively and proactively, when a customer needs consultation;
5. develop more strategic and personalized marketing communications for improved marketing techniques and improved customer satisfaction;
6. help accelerate market development.
   Moreover, relative to the above actual behavior, actual shopping cart activity can be compiled into an individual profile or group profile to engender customer loyalty.

Thus, as can be surmised, the application of this investment technology herein is centered on the goal of revenue growth through cross sales, increased impulse purchases, up-sell opportunities and repeat purchases stemming from increased customer confidence in the website. The technology herein drives the offering of a group of optimization products, as well as consulting services to strategically and effectively utilize the information from the analysis reports to generate additional website revenues. Included in this process is a capability to incorporate a privacy audit from a third party.

The following is a generalized hypothetical example of the technological approach herein could potentially apply to any business entity and its customers, displayed graphically and described. Specifically, the web interaction engine privately tracks each visit by an individual to the website storing action data and the shopping cart results or other results of their visits. Through this process, through such a privacy guard, the tools used develop an understanding of the behavior and attitudes of the website customers or users. In the process a wide array of potential other attributes of website usage are obtained including tracking the most profitable customers and customers who actually close shopping carts. From this information, one can segment groups of customers based on specific behavior or attitudes of customer groups. The result of this data could lead to understanding that higher volume customers tend to make their purchase after visiting the site three times, for instance, within a week, however with the knowledge that potential purchases likely decreases significantly if the particular user visits only twice during that week. This information would be valuable to the business entity, as it can increase purchases by sending out proactive communications to customers following such second visit in a week.

This is one general example of a multitude of scenarios leading from the function and benefits of the system conceived and structured herein. The system clearly provides web site owners with a better understanding of their website visitors, and attitudes and habits for eventual business decisions.

Furthermore, with this software vehicle, a website can support proactive and reactive web site customer engagement, on-request chat, and voice over methodology. The system herein, as seen, permits one to track a customer's progress through a specific website and proactively engage customers or website users in real time conversation, or offer conversational assistance when requested. Such colloquy with customers will help lead customers to locations on the website using the customers own browsers, or by using real time messages, pages, hyperlinks, and other files in order to save the customer and the website monitor time. Moreover, this system integrates with the standard shopping cart on e-commerce sites, providing website monitors with forms, completion errors, or value thresholds and by such the web site monitors can view forms, including errors, and either update the form directly or offer help to the customer.

Furthermore, with such a system one can filter and route customers to a specific sales or service representative or specific group. Additionally, the service will aid in efforts to prioritize customers based on several aspects, including determined shipping cart contents and value, prior website behavior, customer personal information, specific regional areas of customers, routes of navigation to a specific page or area of the site, or time spent on a website page or sites, all among other areas of information. This information will aid the website owner to attain and keep customers, as is the goal of any business.

As can be understood, monitoring and managing communications with customers is more meaningful for fostering a productive relationship. The complete management environment of the subject system lets one review website conversations, create global messages, measure productivity, monitor a customers' receptions, and customize engagement strategies. Reporting, in this respect, would includes determining the number of surfers on given website, total number of conversations, number of times websurfers are proactively engaged, and number of reactive engagements handled. Also, to be obtained is information on past visits, shopping history, current pages visited, or items currently in the shopping cart is on a given website visit-all available to the service representative on the desktop. All such information can be prepared in personalized notes, which notes are date and time-stamped, stored, and made available to service representatives during repeat visits by a specific individual website users.

In overall perspective, the system at hand, provides a full level of services for potential users of the system setforth herein. These uses for the website owner may include the following capabilities:
A. Chat Tracking
   Track a customer's progress through a Website
   Proactively initiating a chat session
   Reactively chatting with a customer
   Defining schedule/hours of operation
B. Conference/Transfer Capabilities
   Transferring chat to another agent
   Viewing available resource by skills or area of expertise
   Allocation agent-to-agent and conference with customer
C. Embedded Browser Help
   Yielding in a built-in browser with “page push” “forms push” capability
   Pursuit of links within a chat session or into a separate browser window.
D. Form Services
   Providing alerts on completion errors
   Allowing to view forms in real time
   Updating forms directly or answer questions
E. Alarm Capabilities
   Allows for entry or leaving page/site; with specific time on page/site; and initiate request for contact
F. Customer Profile Capabilities
   Identify visitors at site entry
   Help in retrieve customer information from the Website's data store
   Providing real-time access to prior visit information including page navigation, personalized notes, and conversations logs
G. Personalized Notes Assistance
   Storage of notes about each customer interaction
   Provisions for notes are date and time-stamped, stored, and made available for repeat visits by the website user
H. Provision of a Response Library
   Provision for a predefined library of text messages, Web pages, hyperlinks, and files
   Available of global and individual presets
I. Collaboration Activities
   Collaboration with customers using browsers
   Broadcast messages to multiple client simultaneously
J. Filtering Aspects
   Provides a shopping cart contents and value; customer information; pages visited; Website zones/areas; IP address; products or prices of items
K. Routing Features
   Provides online assignment of customer to a specific sales rep or group
L. System Administration
   Provides web-based tool to create and configure users, groups, filters, global preset messages, files and Web pages
M. Branding Features
   Completely customize customer-facing interface including logo, color, position, and look and feel
N. Supervisor Management Tools
   Helps monitor conversations in real time
   Helps create-global messages
   Monitor and measure performance
O. Custom Reports Features
   Yields number of surfers on your site
   Yields total number of conversations
   Yields number of proactive and reactive chats
P. Third-Party Integration Aspects
   Gives display legacy data and third-party applications
   Gives external customer ID integration
   Integrates with e-mail routing and management solution
   Initiates VoIp conversation from chat dialogue
Q. Open Architecture
   Provides ODBC-compliant, link to third-party, business, and sales systems
   Provides trace programs
R. Minimum Operating Requirements as Follows
   Has Enterprise Server
   Has Pentium III 500 with 512 MB RAM
   Has Windows NT 4.0 (Service Pack 4 or later),
   Has Windows 2000
   Has Internet Explorer 4.01
   Has (Service Pack 1 or later)
   Has Microsoft SQL Server 7.0
   Administrator & FAT Client
   Pentium III with 128 MB RAM
   Windows NT 4.0 (Service Pack 4), Windows 2000 and/or Windows 98

The usage of this system as outlined just above can be applied to many area of business or commerce and otherwise and the following comprises some of the potential business areas that could benefit from the system.
A. E-Retail—Need to develop greater understanding of customer behavior and ability to strategically and effectively communicate with customers to develop profitable relationships.
B. Financial Services—Need for private and proactive interaction applications to increase the success rate of marketing communications with prospective customers. Provide and insure GLB (Graham, Leach, and Bliley Act) compliance over the Internet.
C. Healthcare—Allow HIPPA (Health Insurance Portability and Accountability Act) compliant internet communication channel between customers and websites, providing trusted communication and improving the relationship and retention.
D. Other industries including but not limited to transportation, wholesale sales, criminal justice responses, services, and manufacturing.

Based on the above background, the contents or modes of a web site visit are stored and the stored data can be revisited by the website owner. A display can be obtained of the stored data. Such stored information may include, as stated above, among numerous data items the following:
(1) length of the visit;
(2) the time of the visit, date and herein;
(3) the result of the visit—such as was there a purchase selection, or action on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;
(9) what is the geographic location of the website user,
(10) if the website user visits the website frequently what products are purchased and at what frequency;
(11) if the website user registered any complaints, and with what rhetoric;
(12) whether the user was satisfied or dissatisfied through registered comments on the site;
(13) credit history of client;
(14) payment history of client;.

Other information can be gathered in such system for later analysis in the overall system, including web site or other conversation data.

In order to achieve all the stated goals and reach all the potential applications and business areas, set forth above, the focus of this invention is a software programming mode detailed to retrieve data stored in the web site storage device and assemble such data in a format, statistical or otherwise that enables the website owner to better understand the attitudes and habits of customers at its website, as such data that can help the owner prepare more effective and efficient marketing programs as well as potentially modifying the website to better accommodate the trend of usage by habit or attitude to and or to promote to certain users other products and advantages, or provide appropriate incentives such as discounts or the like. To this end, the program envisioned herein will be threefold. The first aspect will be provide an appropriate mechanism to recover the necessary data and store same in some organized format that lends itself as a second stage, to a structurally efficient retrieval for program users. The salient aspect of the program is to collate a total overall information and perspective, statistically or otherwise, as a overall overview of the habits and attitudes of individuals and potentially all of the web site customers on an over-all basis—all in order to obtain some idea of what the average user does on the website and whatever attitudes can be reflected as a mean—with the focus on attitudes.

What is new by this process is the variety and depth of such attitude information to be recorded and stored, and most importantly how such attitude data is later processed so as to be presentable in a simplistic format. For this purpose the subject program will be center on the input of such attitude and habit data into a storage unit, with the data processed for informational understanding and then transferred to a secondary storage medium according to the following format:
Enter Data in System—Store Data—Process Data Into Statistical or other format

In other words, the initial raw input data will be stored in a first unit in such raw form as for each individual user of the website. This data must then be transferred into a intermediate processing unit that organizes the data according to a predetermined format using any organized approach. The next step will be to store this processed collated data for an overall view of each customer for subsequent retrieval. The website owner will thus have two types of stored data that can be useful in the overall process. This would include the stored raw data for each individual, while the second storage mode will hold the processed data, such data including stated averages or other overall data for the use thereof by categories—so that the owner can determine the general average type of usage as to all users. Both sets of data (raw and processed) will be useful to the website owner.

The fundamental approach to this blending of attitude and behavior is that it is constituted from specific individuals providing personal data for the use in defining a personalized marketing approach for the customer and other customers who demonstrate similar blended characteristics. This personalized proactive marketing knowledge can then be segmented and specific marketing actions taken to benefit both the customer, to meet such customer needs and requests, and thereby help the business entity achieve its marketing goals.

In a final overall summary of the product process; data is collected real time on customer attitude and behavior from two data streams, actual conversations and actual behavior/actions taken by the customer. These data streams can come from three direct marketing channels, Internet, Email, and Telephony, and are gather and combine by “Channel Adapters” into a database and reported back to the marketer in separate attitude and behavior reports and in combined reports—both attitude and behavior. This data is also used in a business rules engine to provide specific marketing offers or events to returning customers based on their past reported attitude and behavior. This business rules engine can provide a personalized offer to an individual or to multiple customers. A further manipulation of the data is done in the analytic engine that identifies other individuals who demonstrate similar attitudes or behaviors to the captured data of other customers so proactive marketing events can take place to proceed stimulant to achieve specific company goals. Company adapters then are used to combine the three direct marketing channels into a single database of customer attitude and behavior which the analytic and business rules engine call define to provide specific marketing even actions to specific customers or combination of customers.

### H. DESCRIPTION OF A SPECIFIC EMBODIMENT

In describing the specific embodiment of the subject invention, it is to be stressed that by describing one specific embodiment of the subject invention as more fully delineated below, it shall not restrict or limit the scope of the subject invention as set forth in the description and the claims appended hereto, as several embodiments of the invention herein described are contemplated.

The subject invention comprises a process that provides for a basis that allows for analyzing characteristics of website users, indicating the behaviors and attitudes of particular individuals or entities using a given website on the internet from a perspective of both real-time and historical time, with attitude attributes extracted from characteristics and verbal colloquy used by a customer on such website. This attitude data relative to such website is extracted and interpreted and stored on an individual basis and potentially on a group basis for future reference for many purposes, including improving customer relations. Among other matters, attitude data is obtained in this process from interactive real-time communication, usually bi-directional live communication, that the user conducts on specific web site visits, emails or telephone callings, or any other mode of communication to a website or by other modes used in the offering of services or products.

Stated in general, the subject invention is a system for ascertaining specific characteristics of relevant attitudes and habits of website users on a general overall basis and from an individual basis as being delineated as to specific or non-specific categories. As to specific categories, website usage is studied to ascertain specific habits, behavioral modes and particularly attitudes of the user, such as the users attitude towards a given website, its products, and services and other relevant aspects of the website offerings. This information is collected from either a statistical, stochastic mode or from a generalized informational format; and various analysis modes can be used for such purpose.

Alternately stated, the subject invention comprises a process that allows for analyzing characteristics of website users, indicating the behavior and attitudes of a particular individual or entity using a given website on the world wide web (internet) from a perspective of both real-time and historical time, looking to individual website usage habits such as, for example: what pages the user visited, when the user visited, the order of the pages that the user followed on the site, how long the user visited, and how often the user visits the site, among any number of other habit characteristics. This habit data is then stored and updated on an individual basis and potentially on a group basis for future reference purposes. Moreover, most significantly and somewhat critical, customer attitudes can be obtained from such habit characteristics, but mostly such attitude data is available from interactive real-time communications, defined as bi-directional live communication or other communications, that the website user conducts on specific web visits or on several such visits or through emails, telephone, or any other method of spoken or written communication or any other means employed by the user.

In this respect any website user, implicitly or explicitly expresses attitudes in the usage of the website. These implicit or explicit expressions of attitude through questions and general conversations, in the usage of an internet site will reveal specific attitude information. The collection and ultimate usage of such attitude data will substantially help the website user adjust his website format and services for improved customer satisfaction and loyalty.

Further, this attitude information forms in large part the main and critical focus of the subject invention as such website attitude data can provide the most valuable informational tool to help determine ways to improve customer relations. Thus, the subject invention, from a broad perspective, involves herein a structural system to allow the owner of a given website to review particularized usage characteristics of an individual to learn more fully the likes and dislikes of a customer, and his or her perceptions and impressions, referred to as attitudes of a multitude of aspects of the business. Such website monitoring potentially senses activity and attitudes involved from one individual use and attitude to another. By obtaining such customer information, the website owner will learn from data what steps may be needed to improve the website, and cater to the desires and practices of such users. This will obviously help the web owner learn more about unique characteristics of his potential customers or clients for a specific website and learn better how to structure and use such website to keep customers and gain more customers.

In order to practically effect these means, as stated, the subject invention comprises a process and means for structural analysis to obtain a statistical or other overview of all the websites users in the system. The overall processing system includes basic steps more fully outlined below.

One such approach, of several, that can be utilized to determine customer attitude attributes, would be to use particularized categories of habit and behavior and determine attitude attributes therefrom and place such information in an overall matrix. This matrix will have, for example, one or more approaches listing of the various categories that are to be studied in this analysis wherein some limited data can be determined from specific habits and traits of an individual, including on web site dialogue.

In this latter perspective, the habits of a website user arise from the entire input he or she places in the system. Specifically, in on-line communication or other on-line services, an individual using a keyboard will connect with a website in real time on a display screen. Using a personal computer or other vehicles for making website entries and possibly conducting conversation in this process, such as asking questions about the web site, the individual user can perform various tasks on the computer, including entries into the system and conversational interchange over any length of time. The contents or modes of this visit, including conversation, are stored and the stored data can be revisited by the website owner to analyze the same for determining possible needed improvements to the owners entire business mode. Such stored information may include, by way of example, among numerous data items the following usage or habit characteristics, including conversational characteristics:
(1) length of the visit;
(2) the time of the visit, date and herein;
(3) the result of the visit—such as was there a purchase selection, or action consummated on the website as such website contemplates
(4) was there any particularized questions in addressing the website;
(5) how frequently was the website visited by an individual;
(6) how long did the website visitor dwell on a new area of subject on the website;
(7) what was the category of section or purchase by the we site user;
(8) how much money was spent by the individual at the website, if appropriate;
(9) what is the geographic location of the website user;
(10) if the website user visits the website frequently what products are purchased and at what frequency;
(11) if the website user registered any complaints, and with what rhetoric;
(12) whether the user was satisfied or dissatisfied through registered comments on the site.
(13) credit history of client;
(15) payment history of client;
(16) many other areas of usage, or other information about the usage, including, but not limited to attitude information stemming from either unidirectional or bi-directional conversation between the website user and the website monitor.

Once this data is stored, it becomes a source of continually renewable information that could be at hand to evaluate the habits and especially the attitudes of the website user. As stated, this conversational information and usage habit data will be analyzed from many aspects and parameters to determine an individual's attitudes on many facets of the website service, such as product delivery, product inclinations and dislikes, website responses, among a complete array of additional attitudes facets.

In this regard, the core technology architecture employed herein centers around and is thus mainly focused on real-time communications, personalization, and download technology, as consummated through a single agent interface for targeting single point customer from knowledge and communications as found on the web. Moreover, this core architecture is the main impetus for the key features of the technology herein, directed through browser-based communications, behavior/revenue studies, personalization technology, with a single-pixel intelligence engine. The technology architecture combined with the base technology features produces a customer personalization analytics communicator (CPAC) engine. From a broad perspective, involved herein this is a structural system that is provided to allow, in particular, the owner of a website to review particularized usages to learn precisely and generally what type of activity is involved from one individual use to another, including customer attitude reflections.

Moreover, relative to the projected usage of the inventive technology herein, the proposed thrust is to gain maximum insight customer into communications for ascertaining attitudes. In this process behavior and attitude analysis combined with direct customer communication over the web will function to help find ways to increase client satisfaction and thereby maximum return on investment. This information technology will also enable the website owner to:
1. Improve the understanding of customer website navigation and customer purchase or non-purchase behavior on the website;
2. improve website design to maximize purchases and their revenue based on visitor patterns and behavior;
3. generate incremental website revenue from potential customer impulse purchases and increased overall purchase demand;
4. initiate real-time effective and productive communication with customers, both reactively and proactively, when a customer needs consultation;
5. develop more strategic and personalized marketing communications for improved marketing techniques and improved customer satisfaction;
6. help accelerate market development.
   Moreover, relative to the above actual behavior, actual shopping cart activity can be compiled into an individual profile or group profile to engender customer loyalty.

Thus, as can be surmised, the application of this investment technology herein is centered on the goal of revenue growth through cross sales, increased impulse purchases, up-sell opportunities and repeat purchases stemming from increased customer confidence in the website. The technology herein drives the offering of a group of optimization products, as well as consulting services to strategically and effectively utilize the information from the analysis reports to generate additional website revenues. Included in this process is a capability to incorporate a privacy audit from a third party.

The following is a generalized hypothetical example of the technological approach herein could potentially apply to any business entity and its customers, displayed graphically and described. Specifically, the web interaction engine privately tracks each visit by an individual to the website storing action data and the shopping cart results or other results of their visits. Through this process, through such a privacy guard, the tools used develop an understanding of the behavior and attitudes of the website customers or users. In the process a wide array of potential other attributes of website usage are obtained including tracking the most profitable customers and customers who actually close shopping carts. From this information, one can segment groups of customers based on specific behavior or attitudes of customer groups. The result of this data could lead to understanding that higher volume customers tend to make their purchase after visiting the site three times, for instance, within a week, however with the knowledge that potential purchases likely decreases significantly if the particular user visits only twice during that week. This information would be valuable to the business entity, as it can increase purchases by sending out proactive communications to customers following such second visit in a week.

This is one general example of a multitude of scenarios leading from the function and benefits of the system conceived and structured herein. The system clearly provides web site owners with a better understanding of their website visitors, and attitudes and habits for eventual business decisions.

Furthermore, with this software vehicle, a website can support proactive and reactive web site customer engagement, on-request chat, and voice over methodology. The system herein, as seen, permits one to track a customer's progress through a specific website and proactively engage customers or website users in real time conversation, or offer conversational assistance when requested. Such colloquy with customers will help lead customers to locations on the website using the customers own browsers, or by using real time messages, pages, hyperlinks, and other files in order to save the customer and the website monitor time. Moreover, this system integrates with the standard shopping cart on e-commerce sites, providing website monitors with forms, completion errors, or value thresholds and by such the web site monitors can view forms, including errors, and either update the form directly or offer help to the customer.

Furthermore, with such a system one can filter and route customers to a specific sales or service representative or specific group. Additionally, the service will aid in efforts to prioritize customers based on several aspects, including determined shipping cart contents and value, prior website behavior, customer personal information, specific regional areas of customers, routes of navigation to a specific page or area of the site, or time spent on a website page or sites, all among other areas of information. This information will aid the website owner to attain and keep customers, as is the goal of any business.

As can be understood, monitoring and managing communications with customers is more meaningful for fostering a productive relationship. The complete management environment of the subject system lets one review website conversations, create global messages, measure productivity, monitor a customers' receptions, and customize engagement strategies. Reporting, in this respect, would includes determining the number of surfers on given website, total number of conversations, number of times websurfers are proactively engaged, and number of reactive engagements handled. Also, to be obtained is information on past visits, shopping history, current pages visited, or items currently in the shopping cart is on a given website visit-all available to the service representative on the desktop. All such information can be prepared in personalized notes, which notes are date and time-stamped, stored, and made available to service representatives during repeat visits by a specific individual website users.

In overall perspective, the system at hand, provides a full level of services for potential users of the system setforth herein. These uses for the website owner may include the following capabilities:
A. Chat Tracking
   Track a customer's progress through a Website
   Proactively initiating a chat session
   Reactively chatting with a customer
   Defining schedule/hours of operation
D. Conference/Transfer Capabilities
   Transferring chat to another agent
   Viewing available resource by skills or area of expertise
   Allocation agent-to-agent and conference with customer
C. Embedded Browser Help
   Yielding in a built-in browser with “page push” “forms push” capability
   Pursuit of links within a chat session or into a separate browser window.
D. Form Services
   Providing alerts on completion errors
   Allowing to view forms in real time
   Updating forms directly or answer questions
E. Alarm Capabilities
   Allows for entry or leaving page/site; with specific time on page/site; and initiate request for contact
F. Customer Profile Capabilities
   Identify visitors at site entry
   Help in retrieve customer information from the Website's data store
   Providing real-time access to prior visit information including page navigation, personalized notes,. and conversations logs
G. Personalized Notes Assistance
   Storage of notes about each customer interaction
   Provisions for notes are date and time-stamped, stored, and made available for repeat visits by the website user
H. Provision of a Response Library
   Provision for a predefined library of text messages, Web pages, hyperlinks, and files
   Available of global and individual presets
I. Collaboration Activities
   Collaboration with customers using browsers
   Broadcast messages to multiple client simultaneously
J. Filtering Aspects
   Provides a shopping cart contents and value; customer information; pages visited; Website zones/areas; IP address; products or prices of items
K. Routing Features
   Provides online assignment of customer to a specific sales rep or group.
L. System Administration
   Provides web-based tool to create and configure users, groups, filters, global preset messages, files and Web pages
M. Branding Features
   Completely customize customer-facing interface including logo, color, position, and look and feel
N. Supervisor Management Tools
   Helps monitor conversations in real time
   Helps create global messages
   Monitor and measure performance
O. Custom Reports Features
   Yields number of surfers on your site
   Yields total number of conversations
   Yields number of proactive and reactive chats
P. Third-Part Integration Aspects
   Gives display legacy data and third-party applications
   Gives external customer ID integration
   Integrates with e-mail routing and management solution
   Initiates VoIp conversation from chat dialogue
Q. Open Architecture
   Provides ODBC-compliant, link to third-party, business, and sales systems
   Provides trace programs
R. Minimum Operating Requirements as follows
   Has Enterprise Server
   Has Pentium III 500 with 512 MB RAM
   Has Windows NT 4.0 (Service Pack 4 or later),
   Has Windows 2000
   Has Internet Explorer 4.01
   Has (Service Pack 1 or later)
   Has Microsoft SQL Server 7.0
   Administrator & FAT Client
   Pentium III with 128 MB RAM
   Windows NT 4.0 (Service Pack 4), Windows 2000 and/or Windows 98

The usage of this system as outlined just above can be applied to many area of business or commerce and otherwise and the following comprises some of the potential business areas that could benefit from the system.
A. E-Retail—Need to develop greater understanding of customer behavior and ability to strategically and effectively communicate with customers to develop profitable relationships.
B. Financial Services—Need for private and proactive interaction applications to increase the success rate of marketing communications with prospective customers. Provide and insure GLB (Graham, Leach, and Bliley Act) compliance over the Internet.
C. Healthcare—Allow HIPPA (Health Insurance Portability and Accountability Act) compliant internet communication channel between customers and websites, providing trusted communication and improving the relationship and retention.
D. Other industries including but not limited to transportation, wholesale sales, criminal justice responses, services, and manufacturing.

Based on the above background, the contents or modes of a web site visit are stored and the stored data can be revisited by the website owner. A display can be obtained of the stored data. Such stored information may include, as stated above, among numerous data items the following:
(1) length of the visit;
(2) the time of the visit, date and herein;
(3) the result of the visit—such as was there a purchase selection, or action on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;
(9) what is the geographic location of the website user,
(10) if the website user visits the website frequently what products are purchased and at what frequency;
(11) if the website user registered any complaints, and with what rhetoric;
(12) whether the user was satisfied or dissatisfied through registered comments on the site;
(13) credit history of client;
(14) payment history of client;

Other information can be gathered in such system for later analysis in the overall system, including web site or other conversation data.

In order to achieve all the stated goals and reach all the potential applications and business areas, set forth above, the focus of this invention is a software programming mode detailed to retrieve data stored in the web site storage device and assemble such data in a format, statistical or otherwise that enables the website owner to better understand the attitudes and habits of customers at its website, as such data that can help the owner prepare more effective and efficient marketing programs as well as potentially modifying the website to better accommodate the trend of usage by habit or attitude to and or to promote to certain users other products and advantages, or provide appropriate incentives such as discounts or the like. To this end, the program envisioned herein will be threefold. The first aspect will be provide an appropriate mechanism to recover the necessary data and store same in some organized format that lends itself as a second stage, to a structurally efficient retrieval for program users. The salient aspect of the program is to collate a total overall information and perspective, statistically or otherwise, as a overall overview of the habits and attitudes of individuals and potentially all of the web site customers on an over-all basis—all in order to obtain some idea of what the average user does on the website and whatever attitudes can be reflected as a mean—with the focus on attitudes.

What is new by this process is the variety and depth of such attitude information to be recorded and stored, and most importantly how such attitude data is later processed so as to be presentable in a simplistic format. For this purpose the subject program will be center on the input of such attitude and habit data into a storage unit, with the data processed for informational understanding and then transferred to a secondary storage medium according to the following format:
Enter Data in System—Store Data—Process Data Into Statistical or other format

In other words, the initial raw input data will be stored in a first unit in such raw form as for each individual user of the website. This data must then be transferred into a intermediate processing unit that organizes the data according to a predetermined format using any organized approach. The next step will be to store this processed collated data for an overall view of each customer for subsequent retrieval. The website owner will thus have two types of stored data that can be useful in the overall process. This would include the stored raw data for each individual, while the second storage mode will hold the processed data, such data including stated averages or other overall data for the use thereof by categories—so that the owner can determine the general average type of usage as to all users. Both sets of data (raw and processed) will be useful to the website owner.

The fundamental approach to this blending of attitude and behavior is that it is constituted from specific individuals providing personal data for the use in defining a personalized marketing approach for the customer and other customers who demonstrate similar blended characteristics. This personalized proactive marketing knowledge can then be segmented and specific marketing actions taken to benefit both the customer, to meet such customer needs and requests, and thereby help the business entity achieve its marketing goals.

In a final overall summary of the product process; data is collected real time on customer attitude and behavior from two data streams, actual conversations and actual behavior/actions taken by the customer. These data streams can come from three direct marketing channels, Internet, Email, and Telephony, and are gather and combine by “Channel Adapters” into a database and reported back to the marketer in separate attitude and behavior reports and in combined reports—both attitude and behavior. This data is also used in a business rules engine to provide specific marketing offers or events to returning customers based on their past reported attitude and behavior. This business rules engine can provide a personalized offer to an individual or to multiple customers. A further manipulation of the data is done in the analytic engine that identifies other individuals who demonstrate similar attitudes or behaviors to the captured data of other customers so proactive marketing events can take place to proceed stimulant to achieve specific company goals. Company adapters then are used to combine the three direct marketing channels into a single database of customer attitude and behavior which the analytic and business rules engine can define to provide specific marketing even actions to specific customers or combination of customers.

In implementing the foregoing general processing scheme, it is stressed that any website user, implicitly or explicitly expresses attitudes in the usage of the website. These expressions of a attitude through questions, general conversations, in the usage of an internet site will lead to specific attitude information. The collection and ultimate usage of such attitude data will help the website user adjust his website format and services for improved customer satisfaction and loyalty.

This attitude information forms one of the main and critical focus of the subject invention as such website attitude data can provide the most valuable informational tool to help determine ways to improve customer relations. The subject invention, from a broad perspective, involved herein employs a structured system to allow in particular the owner of a website to review particularized usage of an individual to learn precisely and then potentially generally what type of activity is involved from one individual use and attitude to another. By obtaining such information, the website owner will learn from data what steps may be needed to improve the website, by capturing the various characteristics of usage that occur or to cater to the desires and practices of such users. This will obviously help the web owner learn more about unique characteristics of his potential customers or clients for his website and learn better how to structure and use his website. In order to practically effect these means, as stated, the subject invention comprises a process and means for structural analysis to obtain a statistical or other overview of all the websites users in the system. The overall processing system includes basic steps more fully outlined below.

Specifically, an individual using a keyboard will connect with a website in real time on a display screen. Using a personal computer or other vehicles for making website entries and possibly conducting conversation, in this process, such as asking questions, the individual user can perform various tasks on the computer, including such conversational interchange over any length of time. The contents or modes of this visit including conversation are stored and the stored data can be revisited by the website owner to analyze the same for possible improvements. Such stored information may include, by way of example as set forth above, among numerous data items the following usage, habit characteristics as opposed to conversational characteristics:
(1) length of the visit;
(2) the time of the visit, date and herein;
(3) the result of the visit—such as was there a purchase selection, or action consummated on the website as such website contemplates
(4) was there any particularized questions in addressing the website;
(5) how frequently was the website visited by an individual;
(6) how long did the website visitor dwell on a new area of subject on the website;
(7) what was the category of section or purchase by the we site user;
(8) how much money was spent by the individual at the website, if appropriate;
(9) what is the geographic location of the website user;
(10) if the website user visits the website frequently what products are purchased and at what frequently;
(11) if the website user registered any complaints, and with what rhetoric;
(12) whether the user was satisfied or dissatisfied through registered comments on the site.
(13) credit history of client;
(15) payment history of client;
(16) many other areas of usage, or other information about the usage, including most particularly attitude informational stemming from either unidirectional or bi-directional conversation between the website user and the website monitor.

Again, once this data is stored, it becomes a source of continually renewable information that could be at hand to evaluate the habits and especially the attitudes of the website user. This conversational information will be analyzed from many aspects and parameters to determine an individual's attitudes on many facets of the website service. Such as product delivery, product inclinations and dislikes, website responses, among a complete array of other attitudes facets.

In this regard, the core technology architecture employed centers around and in thus focused on real-time communication, personalization, and download technology, as consummated through single agent interface for targeting single point customer knowledge and communications as found on the web. Moreover, this core architecture is the main impetus for the key features of the technology, as browser-based communications, behavior/revenue and personalization technology and a single-pixel intelligence engine. The technology architecture combined with the base technology features produces a customer personalization analytics communicator (CPAC) engine. From a broad perspective, involved herein is a structural system to allow in particular the owner of a website to review particularized usages to learn precisely and generally what type of activity is involved from the individual to use to another. By obtaining such information, the website user will learn from data what steps may be needed to improve the website to capture the various of usage that occur or to cater to the desires and practices of such user. This will help the web owner learn more about the characteristics of his potential customers or clients for his website.

In order to effect these means as stated, the subject invention comprises a process and means for structural analysis to obtain a statistical or other overview of all the websites used in the system. The overall processing system includes basic steps more fully outlined below. One such approach, among many possible, would be to particularize categories of habit, attitude and behavior and set forth same in an overall matrix arrangement. This matrix will have, for example, one or more approaches listing of the various categories that are to be studied in this analysis as set forth in such matrix for identification purposes. Thus, the matrix could have vertical columns with delineated habit and attitude categories, with quantitative verbal delineations in the horizontal bars to characterize or groups for the type of behavior studied. This matrix could serve as a focal point for computer analysis in a program that collates such information and provides a statistical summary, particularly if there is to be an analysis and summary of all users. This matrix approach is more fully discussed below, as one of several organizational formats that can be used for this purpose.

In this process, an individual utilizing on-line communication or other on-line services, through a keyboard or other mechanism can communicate with a website in real time. Using a personal computer for communication, a conversation mode is executed or other communication modes permitted by the system in order to properly use the website.

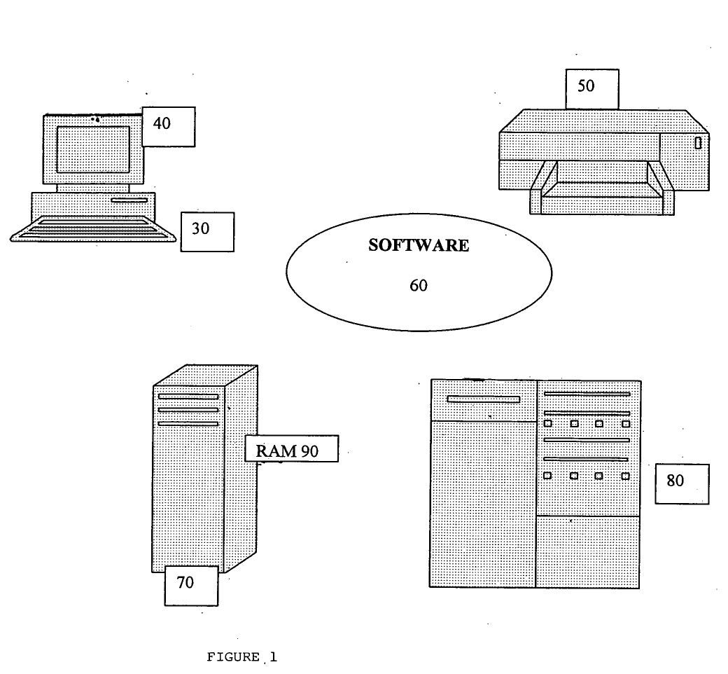

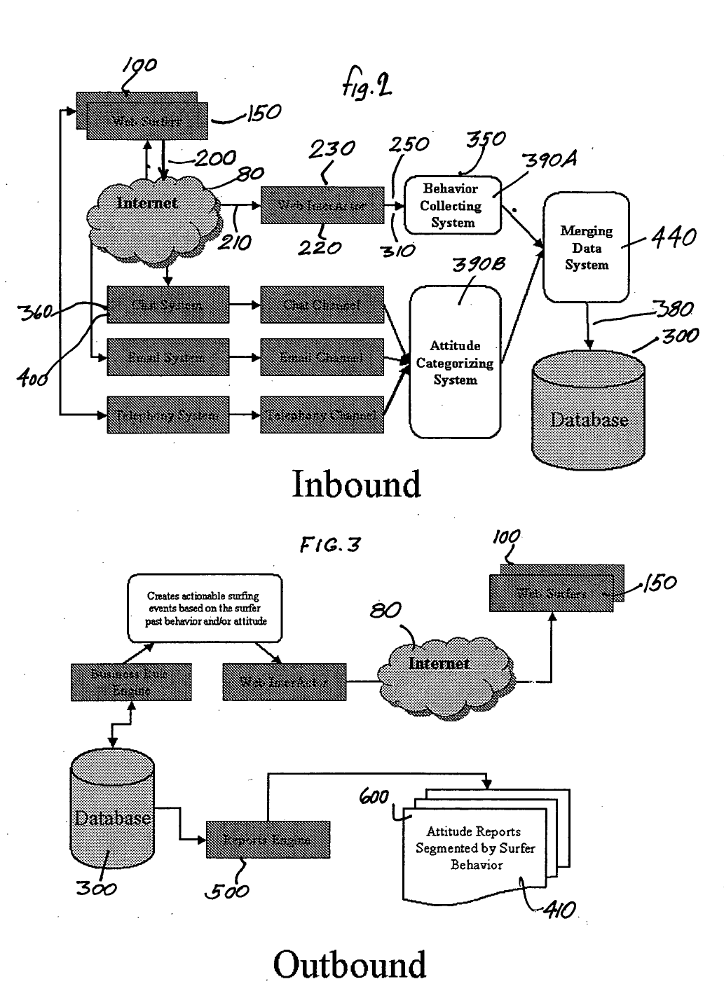

In this respect, referring now to FIGS. 1 and 2, which is a schematic illustrating and overview of the hardware elements used directly or remotely in accordance with the embodiment herein. As illustrated, client computers 10 and web information site 100 are coupled to one another through the internet network 80 by such hardware elements. Individuals seeking internet usage through computers 10 enter the internet and attempt to visit a specific information site 100, and peruse information pages 130 therein. More specifically, the data processing apparatus used will involve a keyboard 30 connected to a processor 75, which can be connected to a communication word processor, which is thence connected to a communication network, through a communication circuit, such as a public communication circuit, a private communication circuit, or the like commonly referred to as the internet 80.

For an algorithmic mathematical perspective, the system herein involves calculating the data from a website that using a receptor that can electronically store such data in an appropriate C.S.U. having R.A.M. units specifically designated and structured to hold such information. In this light, attention is directed again to FIGS. 1 and 2.

In accordance with the present invention, web information site 100 is also equipped to enable a chat session to be dynamically formed on demand between any subset of potential internet users for verbal input. As will be readily apparent from the description to follow, the present invention may be practiced with any number of users, limited only by the processing capacity of any software and hardware elements required herein.

Still referring to FIGS. 1 and 2, information network 100 is intended to represent a broad range of public and private data networks constituted with hubs, routers, switches, gateways, and the like, known in the art. Suitable networking equipment are used to coordinate network access. In one embodiment, the network is the well known Internet having individual information intended to represent a broad range of data sources, business, education, entertainment and the like, constituted with a single or cluster of shared or dedicated computer servers such as web site 100, as an example herein. Information web site pages 115 are intended are intended to represent a broad range of textual and multi-media data embodied in any number of known organization formats. In the embodiment herein, specific web information site 100 having information web site pages 115 is the focus of the subject invention and process embodying same.

Specifically, the web interaction engine in the embodiment herein tracks each visit by an individual to the website 100 storing the activated and verbalized input of an individual to the web site, including shopping cart results or other results of such visits. Through this process, the analysis tools herein develop an understanding of the behavior of the website customers or users; in the process a wide array of potential attributes of website usage yield attitudes and habit data about such individuals. From this information, one can segment groups of customers based on specific behavior of customer groups.

Moreover, with this software vehicle, website 100 can support proactive and reactive web site customer engagement, on-request chat, and voice over methodology. The system herein as seen, the system herein permits one to track a users progress through the web site 100 and proactively engage the users in conversation; or offer assistance when requested. Such colloquy with users helps to lead the user to locations on the web site to save the customer and the website monitor time in the process. Moreover, the system herein integrates with the standard shopping cart on e-commerce sites, providing website monitors with forms, completion errors, or value thresholds and by such the monitors can view forms, including errors, and either update the form directly or offer help to the customer, or make other use of the data as fed into the web site 100.

Furthermore, with such a system one can filter and route users to a specific sales or service representative or specific group. Additionally, the service will aid in efforts to prioritize users or customers based on several aspects, including ultimately shopping cart contents and value, prior website behavior, customer personal information, specific regional areas of customers, navigation to a specific page or area of the site, or time spent on a website page or sites. This information will aid the owner of the web site 100 to attain loyal customers.

This latter information could include determining the number of surfers on given website, total number of conversations, number of times websurfers are proactively engaged, and number of reactive engagements handled. Also to be obtained is information on past visits, shipping history, current pages visited, or items currently in the shopping cart on a given website visit-all available to the service representative on the desktop. All such information can be prepared in personalized notes, with notes are data and time-stamped, stored, and made available to service representatives during repeat visits by a specific individual website user.

The contents or modes of this visit are stored in the storage device 300 for the web site 100 and the stored data can be revisited by the website owner. A display can be obtained of the stored data as needed for further analysis and action. Such stored information may include among numerous data items the following:
(1) length of the visit;
(2) the time of the visit, data and herein;
(3) the result of the visit—such as was there a purchase selection, or action consummated on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;
(9) what is the geographic location of the website user;
(10) if the website user visits the website frequently what products are purchased and at what frequency;
(11) if the website user registered any complaints, and with what rhetoric;
(12) whether the user was satisfied or dissatisfied through registered comments on the site;
(13) credit history of client;
(14) payment history of client;
(15) Other conversational information can be gathered in such system for later analysis.

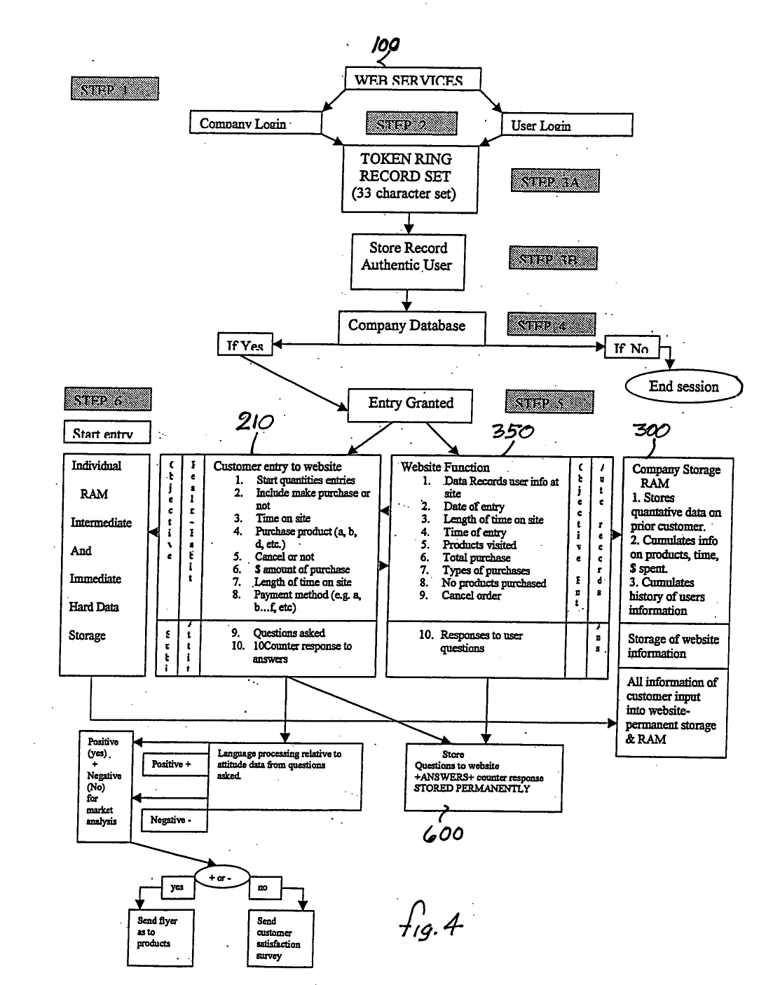

With the above background at hand, attention is directed again to FIGS. 2 and 3 of the drawings which demonstrate an overall processing flow of the basic overall and generalized operational scheme of the subject invention from beginning to the end. Specifically, FIG. 2 is a software processing flow diagram on a general basis.

Again referring to FIG. 2, when a web surface 150 or internet user seeks access through internet 80, using his or her own personal computer and accompanying equipment, as described, the requisite processing apparatus is activated by the user seeking access to a given web site in a word processor mode and document data input is entered through the input section as displayed on user's display screen 40 as text or numerical data entries. When the data processing apparatus is operated in a communication mode, the communication section transmits data such as a required identification number or password for an internet website which is the necessary input from the individual input section to the desired internet web site 100. With this access, circuit connection to the web site 100 is established if the access code is correct or other access means used.

Again, as seen in FIG. 2, in the broader overall perspective in the internet usage, the perspective client enters the internet 80 as step 200 and searches the realm of the internet for particularized web sites seeking particularized information, sales opportunities, web on-line services and other aspects. This step 200 of entrance to the internet is demonstrated in the flow chart is the first step in this process. Upon commencing searching for a particularized website as the second step 210, a specific website 100 is ultimately found. This website is essentially selected as step three 220. At this juncture wherein a website is selected, the client enters his personal access code to gain entry into the website chosen, as step four 230. This entry application process involves several such steps for successful entry to the selected site. One such step could involve a mini or brief application process, involving potentially a credit application and other passable information access such as age, address, employment, social security number for identity and age. This latter step would constitute an adjunct of step four 230.

At the end of the latter step, specific website programs would process the information and accept or reject the request to enter the website and this would constitute step five 240. If the applicant is rejected a “no” entry would be represented, as seen as operational step 250, resulting in denial of entry and the application routed to the “denied” storage area in web site storage unit 300. If the applicant is approved on the other hand, the applicant would be given access to the site, step 310, however, in some instances a second qualifying step would be requested, with such a survey form to be answered on the website. This survey could include any array of questions such as the type of purchases intended, the proposed usage of such, the users overall background or any number of different questions, all of which is generally used to profile the client. If this survey is mandatory for the website usage, then this would be a second request for full access to the website. If on the other hand, the website summary requirements are optional, this summary could be averted by appropriate notice and entry requesting that the survey be passed.

If the entry is rejected for refusal to take the survey which is not optional, as stated above, a rejection notice may be placed in storage for further customer content. Once the client has entered the website, he or she will pursue the data of the website to determine what selections, data or other services he or she will potentially make, These selections will entail such things as possibly or making a selection of one, or several or all the potential products or services available, step six, 350. This selection process may be accompanied by questions entered or completed in this selection process is records as step seven, 360 which step includes entering payment information as substeps 370, and such other information so that the contemplated purchaser or usage is consummated. At this point, the program sequence ends as step 380. It is clear that such website usage enters a vast array of information that are diversely processed by each user, leaving a trace of unique use characteristics delineated above and below.

As a follow-up process step, all the information characterized by web-site visit through the above steps would be stored in an appropriate data base storage unit 300. This stored data may include the following or more:
(a) the name or identification number of customer;
(b) the credit application information;
(c) all the survey information (if the question is answered);
(d) the length of time the client visits the website;
(e) the amount of purchases of the client;
(f) the type of purchases of the client;
(g) the frequency of visits of the client as calculated from private visits and the present visits;
(h) the length of time the client dwelling on one product answer;
(i) the length of time to make the selections;
(j) the type of product information or services selected and the dollar amount of each
(k) the number of times the client cancels or orders;
(l) the number of times a client elects not to select a service and leave the website without a selector;
(m) the types of payment options used by the client;
(n) other types of information characterizes the use of the website by the user.

The foregoing type of information is referred to a habit information, which can yield additional attitude information. Attitude information is best accomplished by a gleaning the credit application, the survey information or the questions asked of the user during the visit to the website.

In this respect, attitude information of the user while being on the website may include the following by way of example:
(1) the credibility or honesty of prospective set user-as based on verification of a credit or other entity application;
(2) the attitudes of the user as demonstrated by the users attitude or the products or services as determined from several questions or questions asked when on the site;
(3) the product preferences of the user-as well as pricing attitudes;
(4) attitudes toward website policies;
(5) cancellation propensity or lack of readiness to purchase;
(6) other attitudes relative to the product, website, company owning or sponsoring the website. All this data relative to attitudes will primarily be turned from questions and dialogue in the chat system 400.

Relative to the habit attitudes many of these aspects can be generated or alternately delineated in a simplistic “yes” or “no” format-or other straight forward representation. On the other hand, the attitude characteristics delineated above are more difficult to translate into a simplistic representative format, however this can be accomplished with an imaginative matrix arrangement first as the habit category, and can be numerically or alpha-numerically focused on a matrix format to accomplish a more efficient programming arrangement. In either event, the attitude and habit information can be processed, stored, and recapitulated or summarized in other than matrix format so long as the end information is presented in a direct and simple to understand format. In this regard attitude data is channeled through the attitude congregting system 390B, which may function additionally as a language content interpreter.

To this end, the program envisioned herein will be threefold. The first aspect will be provide an appropriate mechanism to recover the necessary data and store same in storage data base 300, in some organized format that lends, as a second stage itself to a structurally efficient retrieval for individual users, through a reports engine 500. The salient aspect of the program is to collate a total overall data scheme and representations statistically or otherwise, of an overall overview of the habits and attitudes of individuals and potentially all the users—all in order to obtain some idea of what the average user does on the website and what ever attitudes can be reflected as a mean, as reflected ultimately in attitude reports 600 for individual web site users.

What is new in the storage process of this inventive approach is the variety and depth of such information to be recorded and stored, and most importantly how such data is later processed so as to presentable in a simplistic format. For this purpose the subject program will be center on the input to the data base of web site storage unit 300, with the data processed in a first processor section 500 referred also as the reports engine interconnected to such storage unit and then transferred to a second storage section 600, holding the collated or processed data in computer storage or otherwise.

In other words, the initial stored data will be stored in a first storage unit 300 in the raw form as for each individual user of the website. This data must then be transferred into a secondary processing unit 500, called reports engine, that organizes the data according to a predetermined format using as one mode a matrix approach or other apparatus. The next step will be to store this collated data for an overall view of all customers. The website owner will thus have two types of stored data that can be useful in the overall process. This would include the raw or base stored data for each individual web site user from storage unit 300, while the second storage unit 600 is fed by the secondary processing unit 500 will provide processed or categorized overall data for the individual user 150 in pre-determined in categories—so that the owner can determine the general average type of usage as to the user or all users. Both sets of data will provide useful to the website owner, as stored in the second storage section 410.

The first storage unit 300 with the pertinent data base for individuals, contains the basic raw information. The second processing step of the stored information, as one of the differential aspects of this invention for handling and processing of such information. As one format for representing this data in the data base a matrix can be used as shown in utilizing the system as shown below. It is to noted that the matrix in shown can be the focus of storage in an appropriate RAM, such as the above data base, such as would be included in storage unit 300. Such a matrix is seen as follows:

DATA BANK
Name John Doe

| | 1 | 2 | 3 | 4 | 5 | 6 | 7 | 8 | 9 | 10 |
|---|---|---|---|---|---|---|---|---|---|---|
| No. Of Visits (per | | | x | | | | | | 9 | |
| month) | | | | | | | | | | |
| Length of Visits | | | | | x | | | | | |
| No. Of Purchases | | | | | x | | | | | |
| Time of Visits | | | | | | x | | | | |
| Dates of Visit | 1 | 2 | 3 | 4 | 5 | 6 | 7 | 8 | 9 | 10 |
| Times Spent on | 1 | 2 | 3 | 4 | 5 | 6 | 7 | 8 | 9 | 10 |
| Product A | | | | | | | | | | |
| Time Spent on | 1 | 2 | 3 | 4 | 5 | 6 | 7 | 8 | 9 | 10 |
| Product B | | | | | | | | | | |
| Dollar Amount | 1-5 | 5-10 | 10-20 | 20-30 | 30-40 | 40-50 | 50-60 | 60-70 | 70-80 | 80-90 |
| Spent Per Visit | | | | | | | | | | |

Such a data matrix would be maintained for each individual and could be supplemented and/or modified from time to time as an ongoing update as the user comes back to the website. Once this data is processed in the first processing unit 390A and 390B, it is stored in the RAM storage unit 300 as to individual users. This data from the storage unit 300 is then transferred to a second processing unit 600 where it is to be processed further for data summarization. This second processing unit will now take the data from each of the individual users matrices or data format and process same to be held in a categorized format or run a statistical analysis from all the data of all matters. It is noted that the same computer system will usually incorporate in its hardware and software programming all such multi-processing functions as set forth above. For example, each individual matrix will be scanned and have individual data placed in an overall analysis accordingly to the following general formula as to each category. For example, the average time of visit per individual for each web site use will be:
T(AVE.)=T1+T2+T3 . . . Tn/2,
where n equals the number of website visits selected for the overall survey by such individual.

As an example another category to be analyzed such as the amount of purchases, the formulation used could be simply Pve=P1+P2 . . . Pn, where the dollar amounts are replicated by P1−P2 etc. These as can be seen would be simply average functions to find a new on such data. Each such data area will be analyzed accordingly as the habit of the user sets. The dates or website visitation would be presented and analyzed somewhat differently, as would be users purchase history. For example, already presenting purchase history would be as follow:
Total Purchases by Year=TPI=TP(1)+TP(2) . . . TP(12)

and where the number of total with TPA=Total purchases of all users of per year

Other data can be handled in similar or format appropriate or unique for such. It must be indicated at this point that data which is classified as habit data can be organized, collated, and presented for individuals and groups other than by matrix format or be situation averaging other data methods can be used. It is vital in this respect to understand that this habit data when accumulated will reveal aspects that can determine customer attitudes.

As to conversational input, as shown in FIGS. 2 and 3 storage unit 300 is comprised in part of the communication buffer and the input/save buffer. The communication buffer sequentially stores the verbal communication as verbally stored reception data the transmission data in a transmission/reception order, and stores the reception data and the transmission data in conversation style. The input/save buffer stores input data from the input section, i.e., transmission data, in a transmission order, as seen in the chat system represented in FIG. 2.

When the CPU 350 stores data stored in the communication buffer in the input data file stored in the communication buffer and data stored in the input/save buffer 440 all are compared with each other to determine whether the data is transmission data or reception data. The data which coincides with the data stored in the input/save buffer as determined as the transmission data input from the input section, and the data which does not coincide with the data stored in the input/save buffer are determined as the reception data transmitted from the destination apparatus. If the data is the reception data, predetermined modification information is added and then stored, when the transmission/reception data are read from a file and then displayed or printed, display processing or printing processing on the basis of the modification information added to the data is performed on the reception data. A further step is utilized as such programs to analyze language input to ascertain customer's attitudes about products and customer services, and so forth. The process yields positive or negative attitudes or more refined attitudes. The attitude data is added into a matrix mix or other format used to assemble and hold such attitude data in some organized format.

There are five elements to this latter process. One is the ability to engage proactively or reactivity with a customer on a website through chat technology in chat system 360 and database the conversation specific to the person, time, location, and company agent involved with the customer. This stream of data collection is used in the identification of the website attitude from the user's own words. Second, the system tracks the movement of the individual user over the website and database this behavior specific for the individual as to on page visits, time on the website and database this behavior specific to the individual on page visits, time on the site, navigation through the site, time per page, purchases, and exit page as collected in behavior collection system 350. This stream of data is used to define the customers individual behavior as to actual actions taken and navigation routes used. Third, the reporting of these specific events separately and combined into a summary view which is reflected down to a specific customer. Next, there is a grouping of information into both attitude and behavior of a specific individual, segment, or total perspective based on specific attitude(s) and/or behavior(s) of any segment or individual selected through the merging data system. Fifth, the program processes this information and to a structural or design a specific reaction to the data received in the form of a marketing event or purchase stimulant and provide that marketing event back to the specific individual or segment in real-time on the website or through some other direct marketing channel, as seen in the outbound processing portion of FIG. 2. All of this data is available from a specific time of day, page on the site, up to large blocks of time over several months or customers visits. This ability to build information from a very granular very specific event, cumulatively up and through several events over any amount of time (weeks to months to years) provides unique insight to real time customer knowledge, attitudes and habits. This strategy of data collection is then extended to Email and Telephony as well.

The fundamental approach to this integration of attitude and habit behavior is that it is built up from specific individuals providing personal data for the use in defining a personalized marketing approach for the customer and other customers who demonstrate similar blended characteristics. This personalized proactive marketing knowledge can then be segmented and specific marketing actions taken to benefit both the customer, to meet their needs and requests, and the company/brand to achieve its marketing goals.

This data collection and blending of customer knowledge, attitude and behavior, will include the three most highly used direct marketing channels; including the Internet; email, and telephonic means. The blending of this customer data is unique and we have not been able to identify any company taking this approach.

In summary of the product process; data is collected real time on customer attitude and behavior from two data streams, actual conversations and actual behavior/actions taken by the customer. These data streams can come from three direct marketing channels, Internet, Email, and Telephony, and are gathered and combined by channel adaptors into a database and reported back to the marketer in separate attitude and behavior reports and in combined reports—both attitude and behavior. This data is also used in a business rules engine to provide specific marketing offers or events to returning customers based on their past reported attitude and behavior. This business rules engine can provide a personalized offer to an individual or to multiple customers. A further manipulation of the data is done in the analytic engine that identifies other individuals who demonstrate similar attitudes or behaviors to the captured data of other customers so proactive marketing events can take place to proceed stimulant to achieve specific company goals. Company adaptors are used to combine the three direct marketing channels into a single database of customer attitude and behavior which the analytic and business rules engine can define to provide specific marketing even actions to specific customers or combination of customers.

In general and in summary, the subject invention is a system for ascertaining specific characteristics and habits of web surfers on a general overall basis and from an individual basis being delineated as to specific or non specific category. As to specific categories, the website usages are studied to glean specific habits, behavioral modes and attitudes. This information is collected from either a statistical, stochastic mode or from a generalized informational format over collection and analysis modes can be used for such purpose.

From a broad perspective, involved herein is a structural system to allow in particular the owner of a website to review particularized usages to learn precisely and generally what type of activity is involved from the individual to use to another. By obtaining such information, the website user will learn from data what steps may be needed to improve the website to capture the various of usage that occur or to cater to the desires and practices of such user. This will help the web owner learn more about the characteristics of his potential customers or clients for his website.

There are five elements to this product process. One, the ability to engage proactively or reactivity with a customer on a website through chat technology and database the conversation specific to the person, time, location, and company agent involved with the customer. This stream of data collection is used in the identification of the customer's attitude(s) from their own words. Second, to track the movement of the customer over the website and database this behavior specific to the individual on page visits, time on the website and database this behavior specific to the individual on page visits, time on the site, navigation through the site, time per page, purchases, and exit page. This stream of data is use to define the customers behavior from their actual actions and navigation. Third, the reporting of these specific events separately and combined into a summary view which is drillable down to a specific customer. Fourth, the grouping of information into both attitude and behavior of a specific individual, segment, or total perspective based on specific attitude(s) and/or behavior(s) of any segment or individual selected. Fifth, the ability to take this information and design a specific reaction to it in the form of a marketing event or purchase stimulant and provide that marketing event back to the specific individual or segment in real-time on the website or through some other direct marketing channel. All of this data is available from a specific time of day, page on the site, up to large blocks of time over several months or customers visits. This ability to build information from a very granular, very specific event, up and through several events over any amount of time (weeks to months to years) provides unique insight to real time customer knowledge. This strategy of data collection is then extended to Email and Telephony as well.

The fundamental approach to this blending of attitude and behavior is that it is built up from specific individuals providing personal data for the use in defining a personalized marketing approach for the customer and other customers who demonstrate similar blended characteristics. This personalized proactive marketing knowledge can then be segmented and specific marketing actions taken to benefit both the customer, to meet their needs and requests, and the company/brand to achieve its marketing goals.

This data collection and blending of customer knowledge, attitude and behavior, will include the three most highly used direct marketing channels; including the Internet; Email, and Telephonic means. The blending of this customer data is unique and we have not been able to identify any company taking this approach.

In summary of the product process; data is collected real time on customer attitude and behavior from two data streams, actual conversations and actual behavior/actions taken by the customer. These data streams can come from three direct marketing channels, Internet, Email, and Telephony, and are gathered and combined by channel adapters into a database and reported back to the marketer in separate attitude and behavior reports and in combined reports—both attitude and behavior. This data is also used in a business rules engine to provide specific marketing offers or events to returning customers based on their past reported attitude and behavior. This business rules engine can provide a personalized offer to an individual or to multiple customers. A further manipulation of the data is done in the analytic engine that identifies other individuals who demonstrate similar attitudes or behaviors to the captured data of other customers so proactive marketing events can take place to proceed stimulant to achieve specific company goals. Company adaptors are used to combine the three direct marketing channels into a single database of customer attitude and behavior which the analytic and business rules engine can define to provide specific marketing even actions to specific customers or combination of customers.

In summary, one embodiment of the subject inventory can be described as follows:

A data processing system for a website informational survey of website user attitudes of a website user in such website usage comprising:
(a) computer means for recording and storing into real time website usage habit and language data entered by an individual website user;
(b) computer means to recover said language and habit data and process same to ascertain attitudes of a website user towards said website;
(c) computer means to modify such store attitude characteristics data to a predetermined format;
(d) means to react to said attitude data and to respond to said website user pursuant to said recovered attitudes.

A further summary, of another embodiment of the subject invention is as follows:

A data processing system for a website informational survey of website user attitudes of an individual website user in such website usage comprising:
(a) first computer means for recording and storing real time language usage web site user;
(b) second computer means to interpret said stored language data for attitudes of said website user on a given aspect of said website;
(c) third computer means to form predetermined reactive business modes from interpretations of said attitudes from said second computer means.

Still another summary of another embodiment of the subject invention is as follows:

A data processing system for a website informational survey of website user attitudes of a website user in such website usage comprising:
(a) first computer means for recording and storing in a real time website language usage characteristics indicative of attitudes of said website users towards predetermined aspects of said website and the business mode thereof;
(b) second computer means to recover said recorded and stored said language usage characteristics;
(c) third computer means means adapted to classify and interpret said stored language usage characteristics for specified attitudes of said website user;
(d) fourth computer means to activate predetermined website owner action relative to said attitudes of said website user.

An additional summary of another embodiment of the subject invention is as follows:

A data processing system for a website informational survey of website use attitudes of a website user in such website usage comprising:
(a) first computer means for recording and storing a real time website usage habits and usage language projected by an individual website user;
(b) second computer means to analyze said website habits and website language used by said website user for attitudes on a given website aspect;
(c) third computer processing means to tabulate all such attitude and habit data on a cumulative basis as to website user for determining overall attitudes of such website user on an overall basis;
(d) fourth computer means adapted with predetermined business reactions by said website owner to said determined attitudes of said website users.

A further summary summary of another embodiment of the subject invention is as follows:

A data processing system for a website informational survey of website user attitudes and habits of a website user in such website usage comprising:
(a) first computer means for recording and storing real time website usage language used by an individual website user;
(b) second computer means to analyze said website language asked by said website user for attitudes on a given website aspect;
(c) third computer processing means to tabulate all such language attitudes as to said website user.
(d) fourth computer generated means to initiate a reaction to said stored attitude data to respond to said attitudes of said individual website user.

An alternate summary of another embodiment of the subject invention is as follows:

A data processing system for a website informational survey of website user attitudes of a website user in such website usage comprising:
(a) first computer means for recording and storing a real time website usage questions asked by an individual website user;
(b) second computer means to analyze said web questions asked by said website user for attitudes on a given website aspect;
(c) third computer processing means to tabulate all such attitude data on a cumulative basis as to said website user;
(d) fourth computer generated means to initiate a predetermined reaction to said stored attitude data to improve loyalty of said website user to said website business;

(e) Reactions means to effect an actual external reaction step by said website owner directed specifically to said individual website user website owner as based on said computer perceived attitudes of siad individual website user.

A variant summary of another embodiment of the subject invention is as follows:

A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
   (1) length of the visit
   (2) the time of the visit, data and herein;
   (3) the result of the visit—such as was there a purchase selection or action consummated on the website as such website contemplates;
   (4) was there any particularized questions in addressing the website;
   (5) how frequently was the website visited by an individual;
   (6) how long did the website visitor dwell on a new area of subject on the website;
   (7) what was the category of section or purchase by the website user.

Another summary of another embodiment of the subject invention is as follows:

A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
   (1) length of the visit
   (2) the time of the visit, data and herein;
   (3) the result of the visit—such as was there a purchase selection or action consummated on the website as such website contemplates;
   (4) was there any particularized questions in addressing the website;
   (5) how frequently was the website visited by an individual;
   (6) how long did the website visitor dwell on a new area of subject on the website;
   (7) what was the category of section or purchase by the website user;
   (8) how much money was spent by the individual at the website, if appropriate;

Still a further summary of another embodiment of the subject invention is as follows:

A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
   (1) length of the visit
   (2) the time of the visit, data and herein;
   (3) the result of the visit—such as was there a purchase selection or action consummated on the website as such website contemplates;
   (4) was there any particularized questions in addressing the website;
   (5) how frequently was the website visited by an individual;
   (6) how long did the website visitor dwell on a new area of subject on the website;
   (7) what was the category of section or purchase by the website user;
   (8) how much money was spent by the individual at the website, if appropriate;
   (9) what is the geographic location of the website user.

An additional summary of another embodiment of the subject invention is as follows:

A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
   (1) length of the visit
   (2) the time of the visit, data and herein;
   (3) the result of the visit—such as was there a purchase selection or action consummated on the website as such website contemplates;
   (4) was there any particularized questions in addressing the website;
   (5) how frequently was the website visited by an individual;
   (6) how long did the website visitor dwell on a new area of subject on the website;
   (7) what was the category of section or purchase by the website user;
   (8) how much money was spent by the individual at the website, if appropriate;
   (9) what is the geographic location of the website user;
   (10) if the website user visits the website frequently what products are purchased and at what frequency.

Still another summary of another embodiment of the subject invention is as follows:

A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
   (1) length of the visit
   (2) the time of the visit, data and herein;
   (3) the result of the visit—such as was there a purchase selection or action consummated on the website as such website contemplates;
   (4) was there any particularized questions in addressing the website;
   (5) how frequently was the website visited by an individual;
   (6) how long did the website visitor dwell on a new area of subject on the website;
   (7) what was the category of section or purchase by the website user;
   (8) how much money was spent by the individual at the website, if appropriate;
   (9) what is the geographic location of the website user;
   (10) if the website user visits the website frequently what products are purchased and at what frequency;
   (11) if the website user registered any complaints, and with what rhetoric.

A further summary of another embodiment of the subject invention is as follows:

A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
   (1) length of the visit
   (2) the time of the visit, data and herein;
   (3) the result of the visit—such as was there a purchase selection or action consummated on the website as such website contemplates;
   (4) was there any particularized questions in addressing the website;
   (5) how frequently was the website visited by an individual;
   (6) how long did the website visitor dwell on a new area of subject on the website;
   (7) what was the category of section or purchase by the website user;
   (8) how much money was spent by the individual at the website, if appropriate;
   (9) what is the geographic location of the website user;
   (10) if the website user visits the website frequently what products are purchased and at what frequency;
   (11) if the website user registered any complaints, and with what rhetoric;
   (12) whether the user was satisfied or dissatisfied through registered comments on the site.

Yet another summary of another embodiment of the subject invention is as follows:

A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
   (1) length of the visit
   (2) the time of the visit, data and herein;
   (3) the result of the visit—such as was there a purchase selection or action consummated on the website as such website contemplates;
   (4) was there any particularized questions in addressing the website;
   (5) how frequently was the website visited by an individual;
   (6) how long did the website visitor dwell on a new area of subject on the website;
   (7) what was the category of section or purchase by the website user;
   (8) how much money was spent by the individual at the website, if appropriate;
   (9) what is the geographic location of the website user;
   (10) if the website user visits the website frequently what products are purchased and at what frequency;
   (11) if the website user registered any complaints, and with what rhetoric;
   (12) whether the user was satisfied or dissatisfied through registered comments on the site;
   (13) credit history of client.

Another summary of another embodiment of the subject invention is as follows:

A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
   (1) length of the visit
   (2) the time of the visit, data and herein;
   (3) the result of the visit—such as was there a purchase selection or action consummated on the website as such website contemplates;
   (4) was there any particularized questions in addressing the website;
   (5) how frequently was the website visited by an individual;
   (6) how long did the website visitor dwell on a new area of subject on the website;
   (7) what was the category of section or purchase by the website user;
   (8) how much money was spent by the individual at the website, if appropriate;
   (9) what is the geographic location of the website user;
   (10) if the website user visits the website frequently what products are purchased and at what frequency;
   (11) if the website user registered any complaints, and with what rhetoric;
   (12) whether the user was satisfied or dissatisfied through registered comments on the site;
   (13) credit history of client;
   (14) payment history of client.

1. A data processing system for a website informational survey of website user attitudes of a website user in such website usage comprising:
(a) computer means for recording and storing into real time website usage habit and language data entered by an individual website user;
(b) computer means to recover said language and habit data and process same to ascertain attitudes of a website user towards said website;
(c) computer means to modify such store attitude characteristics data to a predetermined format;
(d) means to react to said attitude data and to respond to said website user pursuant to said recovered attitudes.

2. A data processing system for a website informational survey of website user attitudes of an individual website user in such website usage comprising:
(a) first computer means for recording and storing real time language usage web site user;
(b) second computer means to interpret said stored language data for attitudes of said website user on a given aspect of said website;
(c) third computer means to form predetermined reactive business modes from interpretations of said attitudes from said second computer means.

3. A data processing system for a website informational survey of website user attitudes of a website user in such website usage comprising:
(a) first computer means for recording and storing in a real time website language usage characteristics indicative of attitudes of said website users towards predetermined aspects of said website and the business mode thereof;
(b) second computer means to recover said recorded and stored said language usage characteristics;
(c) third computer means means adapted to classify and interpret said stored language usage characteristics for specified attitudes of said website user;
(d) fourth computer means to activate predetermined website owner action relative to said attitudes of said website user.

4. A data processing system for a website informational survey of website use attitudes of a website user in such website usage comprising:
(a) first computer means for recording and storing a real time website usage habits and usage language projected by an individual website user;
(b) second computer means to analyze said website habits and website language used by said website user for attitudes on a given website aspect;
(c) third computer processing means to tabulate all such attitude and habit data on a cumulative basis as to website user for determining overall attitudes of such website user on an overall basis;
(d) fourth computer means adapted with predetermined business reactions by said website owner to said determined attitudes of said website users.

5. A data processing system for a website informational survey of website user attitudes and habits of a website user in such website usage comprising:
(a) first computer means for recording and storing real time website usage language used by an individual website user;
(b) second computer means to analyze said website language asked by said website user for attitudes on a given website aspect;
(c) third computer processing means to tabulate all such language attitudes as to said website user.
(d) fourth computer generated means to initiate a reaction to said stored attitude data to respond to said attitudes of said individual website user.

6. A data processing system for a website informational survey of website user attitudes of a website user in such website usage comprising:
(a) first computer means for recording and storing a real time website usage questions asked by an individual website user;
(b) second computer means to analyze said web questions asked by said website user for attitudes on a given website aspect;
(c) third computer processing means to tabulate all such attitude data on a cumulative basis as to said website user;
(d) fourth computer generated means to initiate a predetermined reaction to said stored attitude data to improve loyalty of said website user to said website business;
(e) Reactions means to effect an actual external reaction step by said website owner directed specifically to said individual website user website owner as based on said computer perceived attitudes of siad individual website user.

7. A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
(1) length of the visit
(2) the time of the visit, data and herein;
(3) the result of the visit—such as was there a purchase selection or action consummated on the website as such website contemplates;
(4) was there any particularized questions in addressing the website;
(5) how frequently was the website visited by an individual;
(6) how long did the website visitor dwell on a new area of subject on the website,
(7) what was the category of section or purchase by the website user.

8. A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
(1) length of the visit
(2) the time of the visit, data and herein;
(3) the result of the visit—such as was there a purchase selection or action consummated on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;

9. A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
(1) length of the visit
(2) the time of the visit, data and herein;
(3) the result of the visit—such as was there a purchase selection or action consummated on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;
(9) what is the geographic location of the website user.

10. A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
(1) length of the visit
(2) the time of the visit, data and herein;
(3) the result of the visit—such as was there a purchase selection or action consummated on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;
(9) what is the geographic location of the website user;
(10) if the website user visits the website frequently what products are purchased and at what frequency.

11. A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
(1) length of the visit
(2) the time of the visit, data and herein;
(3) the result of the visit—such as was there a purchase selection or action consummated on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;
(9) what is the geographic location of the website user;
(10) if the website user visits the website frequently what products are purchased and at what frequency;
(11) if the website user registered any complaints, and with what rhetoric.

12. A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
(1) length of the visit
(2) the time of the visit, data and herein;
(3) the result of the visit—such as was there a purchase selection or action consummated on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;
(9) what is the geographic location of the website user;
(10) if the website user visits the website frequently what products are purchased and at what frequency;
(11) if the website user registered any complaints, and with what rhetoric;
(12) whether the user was satisfied or dissatisfied through registered comments on the site.

13. A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
(1) length of the visit
(2) the time of the visit, data and herein;
(3) the result of the visit—such as was there a purchase selection or action consummated on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;
(9) what is the geographic location of the website user;
(10) if the website user visits the website frequently what products are purchased and at what frequency;
(11) if the website user registered any complaints, and with what rhetoric;
(12) whether the user was satisfied or dissatisfied through registered comments on the site;
(13) credit history of client.

14. A data processing system for a website informational survey of usage, said data processing system comprising:
(a) means for recording and storing a real time website usage by an individual;
(b) means for counting a number that can be recorded and stored in RAM numerical format;
(c) means to recover both stored information data;
(d) means to modify and store usage data in mathematical format;
(e) means to tabulate said data numerical data in a statistical format including:
(1) length of the visit
(2) the time of the visit, data and herein;
(3) the result of the visit—such as was there a purchase selection or action consummated on the website as such website contemplates;
(4) was there any particularized questions in addressing the website;
(5) how frequently was the website visited by an individual;
(6) how long did the website visitor dwell on a new area of subject on the website;
(7) what was the category of section or purchase by the website user;
(8) how much money was spent by the individual at the website, if appropriate;
(9) what is the geographic location of the website user;
(10) if the website user visits the website frequently what products are purchased and at what frequency;
(11) if the website user registered any complaints, and with what rhetoric;
(12) whether the user was satisfied or dissatisfied through registered comments on the site;
(13) credit history of client;
(14) payment history of client.
